(19) United States
(12) Patent Application Publication
(10) Pub. No.: US 2022/0249972 A1
(43) Pub. Date: Aug. 11, 2022

(54) Continuous-Feed Vacuum System with Integrated Preheater

(71) Applicant: Jared Varver, South Hadley, MA (US)

(72) Inventor: Jared Varver, South Hadley, MA (US)

(21) Appl. No.: 17/803,096

(22) Filed: Feb. 4, 2022

Related U.S. Application Data
(60) Provisional application No. 63/207,059, filed on Feb. 6, 2021.

(51) Int. Cl. B01D 3/10; B01D 3/42; B01D 1/00

(52) U.S. Cl. CPC B01D 3/106; B01D 1/0082; B01D 1/0017; B01D 3/4294

(57) ABSTRACT

A continuous-feed vacuum distillation system with an integrated pre-heater is proposed. It operates continuously on the material to be distilled and heats such material to near-distillation or distillation temperature before it enters the distillation column. This eliminates the current practice of heating the feed material only to much lower temperatures in a feed vessel before it enters the distillation system and thereby eliminates the loss of distillation efficiency inherent in the conventional practice. Various alternative features of the claimed integrated pre-heater are also claimed.

### CROSS-REFERENCE TO RELATED APPLICATIONS

This application claims the priority date of U.S. provisional patent application 63/207,059, filed Feb. 6, 2021.

### STATEMENT REGARDING FEDERALLY SPONSORED RESEARCH OR DEVELOPMENT

The subject matter of this application is unrelated to any federally sponsored research or development.

### BACKGROUND OF THE INVENTION

This invention pertains to apparatuses for molecular distillation of fluids. Apparatuses for molecular distillation are well known, see, e.g., Burrows, Molecular Distillation (1960), and may be either batch or continuous in nature. In continuous distillation apparatuses, a liquid feed material is fed continuously into the distillation apparatus where it is heated in a distillation column, thereby separating the constituents of the feed material so that the more valuable constituents may be captured and utilized. As commonly practiced, the feed material may be contained and pre-heated in a feed tank separate from the distillation apparatus. This requires keeping a relatively large quantity of feed material heated while it awaits processing. Also, to avoid damaging the feed material by prolonged exposure to higher temperatures, the temperature of the feed material in the feed tank is typically kept significantly below its distillation temperature. This means that when the relatively cold feed material reaches the distillation column, it must there first be heated to distillation temperature before distillation can begin, effectively lowering the efficiency of the distillation column below its theoretical maximum were the feed to enter at or near its distillation temperature.

### BRIEF SUMMARY OF THE INVENTION

The invention proposed is a pre-heater integrated with the continuous-feed molecular distillation apparatus, which pre-heater receives and heats the feed material on a continuous basis as it enters the apparatus and before it reaches the distillation column. The pre-heater raises the temperature of the feed material to just below its distillation temperature. Because the feed material is heated continuously as it flows through the apparatus, the need to maintain relatively large amounts of feed material at high temperature in a feed tank is eliminated. Prolonged exposure of the feed material to higher temperatures is avoided by heating the feed material only just before it enters the distillation column. The inefficiency associated with introducing feed material into the distillation column significantly below its distillation temperature is also eliminated.

### BRIEF DESCRIPTION OF THE DRAWINGS

FIG. 1 is a process diagram of a continuous-feed vacuum distillation system including a pre-heater in accordance with one embodiment of the current invention.

FIG. 2 is a pre-heater in accordance with one embodiment of this invention.

FIG. 3 is a pre-heater in accordance with another embodiment of this invention.

### DETAILED DESCRIPTION OF THE INVENTION

Vacuum distillation systems are well known. As earlier described, they consist essentially of a distillation column and a means of evacuating gases from the column to create a vacuum in the distillation column. In a continuous-feed vacuum distillation system, a liquid feed material is introduced continuously into the distillation column, where it is heated to vaporize selected constituents of the feed material. These vaporized constituents are then recondensed on condensation surfaces located either inside the distillation column (short path) or outside the column, thus effecting the desired separation. These vaporized and condensed materials and the unvaporized residual feed material are segregated into separate streams and collected. The distillation column in such a system may be of any of numerous well-known designs embodying well-known design considerations, as explained in existing literature. Typically a vacuum pump is used to create the vacuum in the distillation column. The type of pump is known to those that are familiar with vacuum distillation.

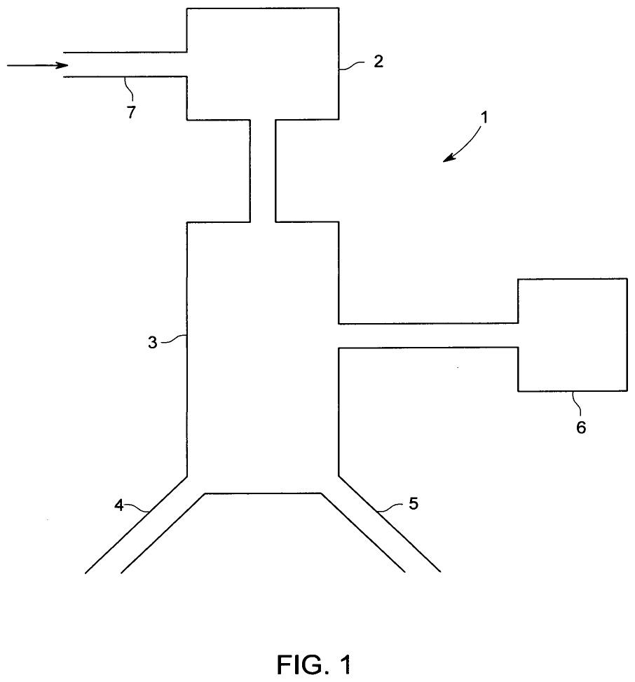

A process diagram of one embodiment of a continuous feed distillation system with an integrated pre-heater is shown in FIG. 1. The distillation system 1 comprises a pre-heater 2, a distillation column 3 of any of the various well-known configurations for such columns, outlets from the distillation column for distillate 4 and residue 5, and a vacuum pump 6 to provide the vacuum to the system. The distillation system may also include a degasser (not shown), condensers (not shown) internal or external to the distillation column, feed, distillate, and residue pumps (also not shown), and electronic controls to control the speeds and temperatures of various pumps, heaters, and condensers in the system (also not shown). Feed material enters the distillation system at the inlet 7, flows through the pre-heater and into the distillation column, where it is distilled, exiting either as distillate or residue through the respective outlets provided. The pre-heater can optionally operate under vacuum or at atmospheric pressure

The pre-heater comprises a heat source surrounding one or more tubes through which the feed material flows. As used here, “tube” denotes any vessel through which a fluid may flow and which need not be of any particular cross-sectional shape. As the feed material flows through such pre-heater tube or tubes, heat is transferred from the heat source through the walls of the one or more tubes to the feed material contained in the one or more tubes, causing the temperature of the feed material to increase. The heat source may be either a hot-oil jacket through which hot oil flows, or an electricity-resistant material, usually a metal, the temperature of which will increase as electrical power is applied to it, or some other suitable means of continuously supplying heat to the one or more tubes.

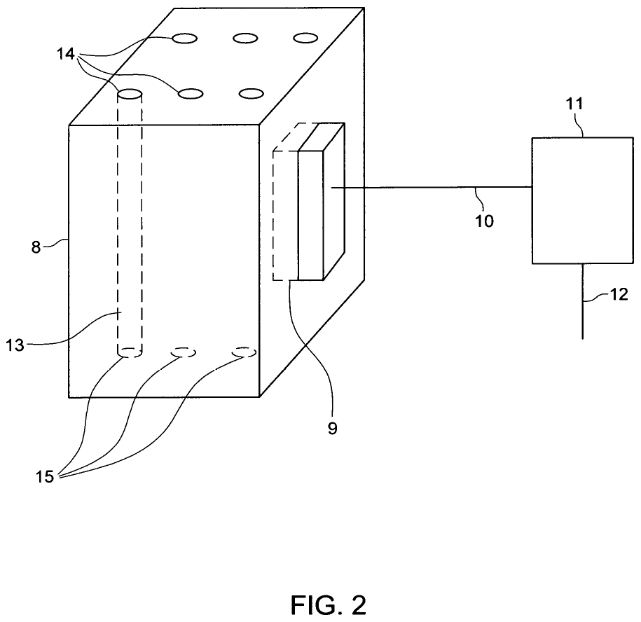

One embodiment of such a pre-heater is shown in FIG. 2. It comprises an aluminum block 8 with one or more electric-resistant heating elements 9 embedded in it. The heating elements are connected by an electricity supply wire 10 to an electronic controller 11, which is connected in turn to an electricity supply 12. When electricity is supplied to the heating elements, their temperature increases, causing the temperature of the surrounding heater block 8 to increase. One or more tubes 13 are provided to carry the feed material from the tube inlets 14 through the block to exit at the tube outlets 15. Heat is transmitted from the heater block through the tube walls and into the feed material flowing through the tubes. Standard engineering calculations, based on the desired flow rate through the pre-heater (selected to match the optimal flow rate through the distillation column), the temperature difference between the feed material at the inlet of the pre-heater and the desired temperature of the feed material at its outlet, and the heat capacity of the feed material, are used to determine the surface area of tubes to be used in the heater block and the range of wattage that will need to be applied to the heating elements in the block. The tube surface area and wattage density should be such that at a feed-material flow rate consistent with the optimum flow rate in the distillation column, the feed material is heated in the pre-heater to a temperature equal to or slightly below the desired distillation temperature in the distillation column. The inventor has found that in a distillation system with a target distillation temperature of 160°-180° C., for example, a pre-heater outlet temperature of 150° is optimal. In this embodiment, an electronic controller of a type readily available commercially is used to regulate the amount of electricity supplied to the pre-heater. Heater blocks, with various tube areas and wattage density ratings, are also commercially available.

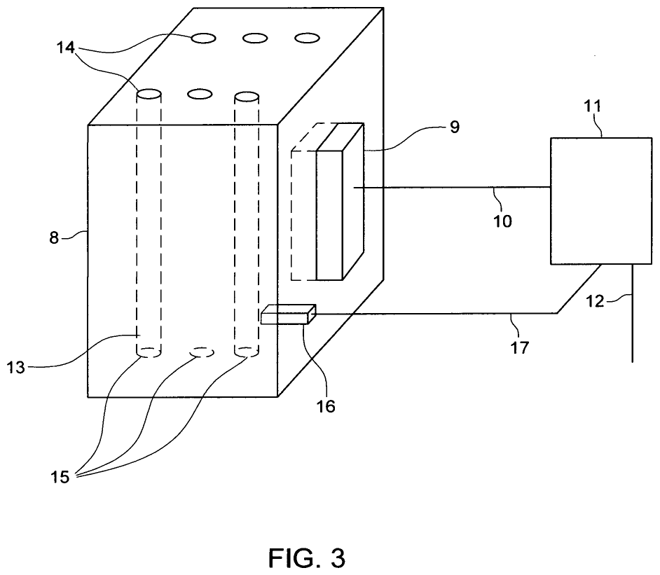

In another, preferred embodiment of the invention, shown in FIG. 3, the pre-heater of the prior embodiment is supplied with a thermocouple 16 to measure the temperature of the heater block or the feed material inside the pre-heater, near the feed-material outlet 15. A control wire 17 connects the thermocouple to the electronic controller 6 of the pre-heater, allowing the thermocouple to report the measured temperature of either the heater or the feed material to the controller on a continuous basis. The controller is programmed to vary the electricity supplied to the heating elements in the heater block continuously to maintain a target pre-heater temperature or feed-material outlet temperature preset by the operator. If the controller adjusts the electricity supply by reference to the heater block temperature, one skilled in the art will be able to calculate the electricity supply needed to achieve the desired feed-material outlet temperature based on the expected inlet temperature, flow rate, surface area of the tubes, and properties of the feed material.

In other embodiments, the electronic controller may regulate the flow rate of feed material through the pre-heater to adjust the temperature of the feed material exiting the pre-heater.

Other advantages and other embodiments of the current invention will be obvious to those skilled in the art. Their omission here is not intended to exclude them from the claims advanced herein.

What is claimed is:

1. A continuous-feed vacuum distillation system comprising a distillation column, a preheater, and one or more vacuum pumps, wherein
(i) the pre-heater comprises a heat source adjacent to or surrounding one or more tubes through which feed material flows into and out of the pre-heater; and
(ii) the surface area of the tubes and the heating capacity of the heat source are such that the flow rate of feed material through the pre-heater and its exit temperature from the pre-heater are consistent with the optimal operation of the distillation column; and
(iii) the vacuum distillation system is arranged so that feed material flows continuously through the pre-heater and then through the distillation column.

2. The continuous-feed vacuum distillation system of claim 1 wherein an electronic controller is also provided through means of which the flow rate of feed material through the pre-heater or the amount of electrical power supplied to the pre-heater, or both, may be varied and controlled.

3. The continuous-feed vacuum distillation system of claim 2 in which the electronic controller adjusts the flow rate of the feed material through the pre-heater or the amount of electrical power supplied to the pre-heater by reference to the temperature of the pre-heater or of the feed material in the pre-heater.

4. The continuous-feed vacuum distillation system of claim 3 wherein
(i) a thermocouple is provided in the pre-heater to measure the temperature of the either the pre-heater itself or the feed material adjacent to the feed material outlet from the pre-heater;
(ii) the said thermocouple is connected to the electronic controller such that the temperature of the feed material measured by the thermocouple is reported to said electronic controller; and
(iii) the electronic controller may be programmed to vary the electricity supply to the pre-heater either continuously or intermittently to maintain a target feed material temperature in the pre-heater.
